(19) United States
(12) Patent Application Publication
(10) Pub. No.: US 2011/0271858 A1
(43) Pub. Date: Nov. 10, 2011

(54) FOUNTAIN SOLUTION REGULATION

(75) Inventor: Jan Pieter Vroegop, Wijk Bij Duurstede (NL)

(73) Assignee: DRS. J. J. A.VAN HESTEREN, Roosendaal (NL)

(21) Appl. No.: 13/129,448

(22) PCT Filed: Nov. 17, 2009
(86) PCT No.: PCT/NL09/00221

§ 371 Date: Jul. 26, 2011

(30) Foreign Application Priority Data
Nov. 17, 2008 (NL) 2002212

(51) Int. Cl. B41F 35/00; C09D 171/02

(52) U.S. Cl. 101/425; 523/122

(57) ABSTRACT

The current invention relates to a method for inhibiting or preventing the growth of micro-organisms in a printing device to which, during a period of printing, a fountain solution is added, characterized that during an interval between two periods of printing the PH value of the fountain solution is changed. The invention also relates to the use of fountain solutions in said method and fountain solutions that can be applied in said method/esp.

### CROSS-REFERENCE TO RELATED APPLICATIONS

This application is the National Stage of International Application No. PCT/NL2009/000221, filed Nov. 17, 2009, which claims the benefit of Netherlands Application No. NL 2002212, filed Nov. 17, 2008, the contents of which is incorporated by reference herein.

### FIELD OF THE INVENTION

Offset printing, or lithography, is a printing technique in which the image to be printed is fixed on a generally flat plate. The lithographic process is based on the principle that oil and water do not mix. Using this principle, the plate is constructed so that the image areas are ink receptive and lipophilic or water repellant and the non-image areas are hydrophilic or water receptive and ink repellant. Fountain solutions, also referred to as dampening solutions, are the agents used in lithography to wet the non-image area of the plate and repel the ink from such non-image areas.

During the printing process, the aqueous fountain solution is generally applied to the plate surface, in addition to the printing ink. The object of the said solution is to keep moist all parts not covered by the hydrophobic picture, in order to ensure that these non-image areas repel hydrophobic printing ink during the printing process.

### BACKGROUND OF THE INVENTION

In conventional systems, the fountain solution can be applied to the plate by a roller system, separated or in contact with the ink roller system. A wide variation in the type and construction of roller dampening systems exist, like Dahlgren, Epic, Duotrol, and Alcolor. Apart from the roller system also contactless systems exist, by means of spraying the fountain solution. Here as well different constructions exist, viz spray dampening, turbo dampening, or Weko.

Fountain solutions need to meet for example the high requirements of offset printing and problems in the form of ink acceptance in non-image areas frequently occur.

Numerous patented and unpatented fountain solutions have been developed over the past several years. By far, the vast majority of such prior art fountain solutions are aqueous or liquid based. U.S. Pat. No. 5,279,648, U.S. Pat. No. 5,268,025, U.S. Pat. No. 5,336,302, U.S. Pat. No. 5,382,298, U.S. Pat. No. 4,865,646 and U.S. Pat. No. 4,604,952 exemplify the state of prior art liquid based fountain solutions.

Normally such fountain solutions comprise a wide variety of compounds; all intended to have distinct functions in the fountain solution. Typically these comprise wetting agents, densistizing agents, evaporation inhibitors, non-pilling additives, corrosion inhibitors and pH buffer systems to maintain the pH of the fountain solutions on the appropriate pH value.

Fountain solutions however contain many ingredients that will act as a food source for micro-organisms like molds, yeasts, bacteria, virus, parasites and the like, including water, paper, materials like gum Arabic, starch-derivates, phosphates, and citric acid. Indeed the growth of micro-organisms in the fountain solution (present in the printing device) is generally known and considered as a problem.

Bacteria in the system can cause drastic changes in conductivity and pH, making fountain solution less effective. Bacteria can also clog spray bars and return lines. In addition, they might spread a nasty smell. Simply put, the more bacteria that appear in the printing system, the more water-related problems will occur on the press.

Various effective classes of biocides have been found to function well in fountain solutions. These include, not all inclusive, ortho phenol-phenol (phenolics), chloro-methyl-4-isothiazolin-3-one (isothiazolines), dimethyldimethylol-hydantoin (formaldehyde donors), quats, certain aldehydes like glutaraldehyde, 2-bromo-20-nitropropane-1,2-diol and other halogen containing biocides like 3-iodo-2-propynyl butylcarbamate. Other biocides include sodium dimethyl dithiocarbamate, 2,4-dichlorobenzyl alcohol, hydrogenperoxide and hexahydrotriazine.

Even though fountain solutions contain several specific biocides to control bacterial growth, they cannot contain enough biocides to totally eliminate the problem. In addition, constant exposure to these biocides might induce sensitivity towards these materials by the person operating the printing system, or working in the vicinity thereof. Biocides form a significant part of the costs of a fountain solution and have impact on the environment.

It is an object of the current invention to provide for a solution to at least one of the above mentioned problems. More in particular it is an object of the current invention to provide for an improved method for controlling the growth of micro-organisms in a fountain solution or in a printing device, allowing reducing the levels of biocides required for effectively controlling growth of micro-organisms.

The object of the current invention is achieved by providing for a method as described in the claims and herein, the use of compounds as described in the claims and herein and providing fountain solution (concentrate) compositions as described in the claims and herein.

More in particular, according to the invention, there is provided a method for inhibiting or preventing growth of micro-organisms in a printing device to which during a period of printing a fountain solution is provided, characterized in that during an interval between two periods of printing the pH value of the fountain solution is brought to a pH value at or below pH=3.0 or to a pH value at or above pH=8.5 and at the end of the interval between two periods of printing the pH value of the fountain solution is brought to a pH value between pH=3.0 and pH=8.5, preferably between and including pH=3.5 and pH=5.7, even more preferably between and including pH=4.0 and pH=5.5.

Within the context of the current invention the term “micro-organism” is to be construed to include molds, yeasts, bacteria, virus, and parasites.

The term “fountain solution” is known to the person skilled in the art. The fountain solution causes the non-image portion of a printing plate to repel ink while allowing the image portion to accept ink. Using offset printing, the ink-coated image is ultimately transferred to a substrate, such as paper, producing an image corresponding to the image on the plate. Various fountain solutions are commercially available and might be applied in the method according to the invention.

During printing, fountain solution is provided, together with ink, to the printing device (or system) in order to allow for desired transfer of ink from a printing plate to a substrate, like paper. It has now surprisingly been found that the growth of micro-organisms in the system can effectively be inhibited or prevented when during a period in which the system is not used to transfer ink from a printing plate to a substrate, for example is not used to print newspapers, the pH value of the fountain solution is increased or lowered to a pH value as described above (below pH 3.0 or above pH 8.5). During such interval between two periods of printing, no fountain solution is consumed by the printing process as no printing occurs.

Thus, the same fountain solution as used for printing during a period of printing is used during an interval between two periods of printing for inhibiting or preventing growth of micro-organisms in a printing device, by changing the pH value of said fountain solution as described above. Thus, the fountain solution used in the period between two intervals of printing in the method according to the invention can be the same, and comprise the same compounds as, as the fountain solution as used during the periods of printing, with the exception that in order to change the pH value as described in the method, an acid or acidic solution or a base or basic solution is added to the fountain solution (see below). There is therefore no need to stop the printing device and replace the fountain solution used for printing with a separate solution, as the same solution can be used, by regulating the pH value of the solutions.

This is in contrast to methods described in the art, for example US 2005/0133460, that use a solution not suitable as a fountain solution in the printing process for removing and cleaning (in contrast to inhibiting or preventing growth of microorganisms) debris and/or require that, in order to apply such different solution, the printing device needs to be emptied, filled with the separate solution, rinsed, again emptied and eventually refilled with a fountain solution.

### SUMMARY OF THE INVENTION

The current invention allows to only modify the pH value of the fountain solution already used in the period of printing during the interval between two periods of printing, and visa versa.

By modifying the pH value of the fountain solution to the values indicated, any or at least most micro-organisms are inhibited from multiplying, thereby effectively reducing the growth of micro-organisms in the fountain solution. It has been found that surprisingly, by the method according to the invention, the concentration of biocide that is required to be present in a fountain solution can be reduced with at least 10, 20, 30, 40, 50, 60, 70, 80, 90 or even 100% in comparison to the level of biocide generally used in the art.

By applying the method according to the invention it is therefore possible to reduce the cost price of fountain solution (concentrates) by lowering the amounts of biocides required to inhibit or prevent the growth of micro-organisms, while at the same time the occurrence of allergic reactions (or sensibilisation) towards the biocides included in fountain solutions might be reduced due to lowered exposure towards such biocides. As the compounds comprised in a fountain solution eventually end up in the environment, in addition, the effect of such fountain solution on the environment is reduced due to the lower levels of biocides present.

However, it is to be understood that it is not a requirement of the current invention that the level of biocides in a fountain solution (concentrate) is too be lowered. In such case, the method according to the invention provides for an additional, complementary and effective additional method for preventing the growth of micro-organisms in a fountain solution.

It will be understood that in a particular preferred embodiment of the current invention, during the interval between two periods of printing, the fountain solution, with the appropriate pH as described above (below pH 3.0 or above pH 8.5), is applied to the printing device (or system), for example in a manner equal to when the fountain solution is applied to the system during a period of printing. In this manner, the fountain solution is lead through the system, allowing to prevent or inhibit the growth of microorganisms in all those parts of a printing device (or system) that normally (during a period of printing) comes into contact with the fountain solution (either directly or indirectly).

At the end of the interval between two periods of printing, the pH value is brought back to a pH value as described (between pH 3.0 and 8.5) to allow for the normal continuation of the print process. As will be understood by the skilled person, the pH value is normally that pH value that is normally applied in the particular printing process.

In a preferred embodiment of the current invention, during an interval between two periods of printing the pH value of the fountain solution is brought to a pH value of pH=8.5 or above. In contrast to lowering the pH value to 3.0 or below, no problem with corrosion of elements in the printing device, for example the printing plate, will occur. In addition, it has been found that a fountain solution with a pH value above 8.5 might advantageously be used for rinsing and cleaning the printing system (device).

In another preferred embodiment of the method according to the invention, the pH value in the interval is brought to a pH value at or below pH=2.5, preferably at or below pH=2.0, or the pH value in the interval is brought to a pH value at or above pH=9.0, preferably at or above pH=10.0.

It has been found that in particular the above-mentioned pH values effectively prevent or inhibit the growth of micro-organisms.

Preferably, the difference between the pH-value of the fountain solution during a period of printing and during an interval between two periods of printing is at least 1, more preferably 2, even more preferably 3 or even 4 or 5 (e.g. pH during printing is pH 5.0, whereas during the interval between two periods of printing the is pH 9 or 10.).

In another preferred embodiment, the printing device is for off-set printing. In particular, the method according to the invention can advantageously be used in off-set printing of newspapers, or other off-set printing procedures with high circulation numbers (above 10000 or even 100000, or 1000000 copies). In particular, in these procedures, there is a high demand for reliable and reproducible printing processes within high time constraints. Therefore, any interference of microorganism with the printing process can have large consequences in providing the newspaper in time (or enough copies).

With the method according to the invention, the growth of micro-organism in the fountain solution and the printing device are effectively prevented or inhibited without (or with less) use of such environmental hazardous compounds like biocides.

As will be understood by the skilled person, the fountain solution can be provided to the printing device from a stock of said fountain solution. In other words, the fountain solution can be prepared in advance and stored and applied to the system when used.

In a further embodiment, the fountain solution (not water alone) applied in the method according to the invention is substantially free of a pH buffer system.

### DETAILED DESCRIPTION OF THE INVENTION

Fountain solutions comprise a pH buffering system in order to maintain a constant pH of the solution. Such buffers system can be any buffer system known in the art and is in the context of the current invention preferably selected from the group consisting of water soluble organic acids, water soluble inorganic acids and salts thereof. Examples of such acids include ascorbic, acetic, citric, gluconic, hydroacetic, hydrochloric, lactic, malic, malonic, nitric, oxalic, phosphoric, tartaric acid. Salts of these organic-inorganic acids include alkali metal, alkaline metal or ammonium salts thereof. It will be understood that these acids and/or salts thereof can be used alone or in combination.

However, preferably, the fountain solution is (substantially) free of any pH buffering system. When a fountain solution with a pH buffer system is admixed with an aqueous solution, a pH buffer solution consisting of a mixture of a weak acid and its conjugate base or a weak base and its conjugate acid is formed. Such solution has then the property that the pH of the solution changes hardly or not at all when a small amount of acid or base is added to it or formed in it (for example due to growth of microorganisms). Indeed, in fountain solutions, buffer solutions are used as a means of keeping pH at a nearly constant value. However, within the context of the current application, the pH value of the fountain solution is to be regulated by the external addition of a base or an acid, and does not longer depend or require the presence of a pH buffer system.

In fact, the presence of a buffer system in the fountain solution might be less desirable within the current invention as the buffering capacity of such buffer system will increase the amounts of acid or base that needs to be added externally to the fountain solution in order to direct the pH of the solution towards the desired value. Consequently, this will increase the level of salts present in the fountain solution. Therefore, it is in a preferred embodiment of the current invention that the fountain solution is free of, substantially free of, or has reduced levels of a pH buffering system like those discussed above.

It will be understood by the skilled person this is to be construed as that preferably the fountain solution or the fountain solution concentrate is free of acids and/or salts that, in the concentration used in a fountain solution, has as task/goal to act as a pH buffering system. In other words, the above-mentioned acids and salts can be present in the fountain solutions in concentrations at which it does not (substantially) contribute to the buffering of the pH of the solution, or functions as such.

An additional benefit of the at least reduced levels of such pH buffer system in the fountain solution or fountain solution concentrate is that it even further reduces the growth of micro-organism in the off-set process and/or device as these salts and acids might normally be utilized by the micro-organism during growth. By reducing the availability, growth of such micro-organism will be further inhibited or prevented.

As discussed above, since water (fountain solution) is a breeding medium in the presence of organic matter for various microorganisms like molds, yeasts, bacteria, virus, parasites and the like, it was important to have biocides at effective concentrations to kill and/or inhibit their growth. Various effective classes of biocides have been found to function well in fountain solutions. These include ortho phenol-phenol (phenolics), chloro-methyl-4-isothiazolin-3-one (isothiazolines), dimethyldimethylol-hydantoin (formaldehyde donors), quats, certain aldehydes like glutaraldehyde, 2-bromo-20-nitropropane-1,2-diol and other halogen containing biocides like 3-iodo-2-propynyl butylcarbamate. Other biocides include sodium dimethyl dithiocarbamate, 2,4-dichlorobenzyl alcohol and hexahydrotriazine. Commercial examples include Kathon (Rohm and Haas) and Acticide (Thor).

Levels of the biocides used are normally low due to the chance of developing allergies or dermatitis and the like upon contact with such biocides (See for example Dermatitis. 2004 June; 15 (2):73-4), but are in practice increased to deal with the problem of growth of microorganisms.

However, as explained above, with the method according to the invention, the level (concentration) of biocides present in the fountain solution can now be reduced in comparison to those fountain solutions described in the art. Therefore, in a preferred embodiment there is provided a method according to the invention wherein the fountain solution is free, substantially free, or has lowered levels of biocide.

In a preferred embodiment the fountain solution is free of hydrogenperoxide and/or glycolic acid.

With the term “substantially free” is meant that the level of biocide that might be present in the fountain solution is at most 50%, 40%, 30%, 20%, 10%, or 0% of the concentration of biocide that would be required to inhibit or prevent the growth of microorganism in a fountain solution when used in a printing device, without applying the method according to the invention, i.e. by only applying fountain solution or fountain solution concentrate to the printing system, without the modification of the pH values as described above.

For example, in the case of isothiazolines, a common concentration in a fountain solution concentrate can be about 300-1000 ppm (parts per million). In a fountain solution, i.e. on the press, in the printing device, the concentration might be further diluted (depending on the fountain solution concentrate and the other requirements of the fountain solution) for example, 30 to 100 times. In case the fountain solution concentrate is for example diluted 50 times, it will comprise, for example, about 6 to 30 ppm of the biocide.

With the method according to the invention is has been found that the concentration of the biocide can be lowered in the fountain solution to levels as low as 0, 1, 2, 3, 4, 5, 6, 7, 8, 9, 10 ppm of a biocide, in particular 0, 1, 2, 3, 4, 5 ppm in the case of for example the isothiazolines.

Fountain solutions are generally known in the art and can comprise a wide variety of different compounds. However only few distinct functions can be attributed to the fountain solution.

It has been found that the method according to the invention can be performed with the help of any fountain solution having compounds to provide for the various distinct function of the fountain solution.

Fountain solutions in general comprise a hydrophilic polymer having the ability of forming a film that protects the non-image of the printing plate. Examples of the hydrophilic polymers include materials such as gum Arabic, starch derivatives like hydroxy propylated, phosphated and carboxymethylated starch, or synthetic polymers such as polyvinyl alcohol, polyvinyl pyrrolidone, polyacrylamide, polyacrylic acid and copolymers thereof, and many other synthetic polymers. The most common hydrophilic polymers (desensitizers) are gum Arabic and carboxy methyl cellulose.

Wetting agents, including typically surfactants, aid in the cleaning of ink from the non-image area of the plate, reducing scumming and toning. A quality surfactant will lower surface tension. This lower surface tension will allow the plate to “wet out” faster, thus allowing printing with the least amount of ink and water required to stay clean. Surfactants also help control emulsification. Ink must absorb water to print. Too much water produces washed-out color and ink spitting. Too little water leads to color variation and slow clean-ups. A quality surfactant controls how quickly and consistently the wetting will occur on press. The wetting agents can also include solvents like glycols, glycol ethers, glycol esters, and surfactants, for example, diethylene glycol, diethylene glycol monomethyl ether, hexylene glycol, glycerin, 1,5-pentanediol, polyols, propylene glycol monomethyl ether, etc. There are numerous other glycol derivatives that are commercially available, and anybody skilled in the art would be capable of substituting them for the above mentioned compounds in a fountain solution.

Alternatively, surfactants with a hydrophilic-lipophilic balance (HLB) in the range of about 2 to about 10 can be comprised in the fountain solution to provide for wetting and lowering surface tension. Some examples include anionic surfactants fatty acid salts, alkanesulfonates, sulfated castor oil, polyoxyethylene-alkyl ether sulfates, polyoxyethylene-alkyl ether phosphates, dialkylsulfo-succinates, and alkylsulfates and alkylnaphthalenesulfonates.

Evaporation inhibitors are added to help leave a residual amount of fountain solution on the plate during shutdown. The residual fountain solution protects the plate from oxidation and ensures quick clean restarts.

Non-piling additives are designed to soften paper fibers. This aids in lowering paper fiber adhesion to the system, improving print quality. Eliminating paper piling is impossible—non-piling additives have been proven to reduce it.

In addition, the fountain solution can comprise a hydrotrope, in particular when a surfactant with a low HLB value is present, and/or due to the presence of large amounts of electrolytes, or corrosion inhibitors with low water solubility or other organic components with low solubility in water.

A hydrotrope is a compound that solubilizes hydrophobic compounds in aqueous solutions. Typically, hydrotropes consist of a hydrophilic part and a hydrophobic part but the hydrophobic part is generally too small to cause spontaneous self-aggregation. Hydrotropes are essentially low molecular weight amphiphilic compounds often resembling surfactants in as much as they have hydrophilic groups like sulfonates, phosphates, or carboxylates, and what in surfactant terms maybe described as a low molecular weight hydrophobe. That is to say that the hydrophilic group is attached to an organic moiety that is too short a group to confer true surface active properties. The most common hydrotropes are aromatic sulfonates, aromatic phosphate esters, and di and polycarboxylates. Specific examples, not all inclusive, are sodium xylene, para toluene sulfonate, cumen sulfonate, sodium p-toluenesulfonate and sodium xylene sulfonate, and mixtures of mono and di-alkyl phosphates.

A chelating compound may be comprised in the fountain solution or fountain solution concentrate to sequester any calcium or magnesium ions found in water. These cations have a tendency to precipitate when they encounter certain anions, and can cause serious problems in the printing process. Without the introduction of the sequestrant, the calcium and other interfering agents tend, for example, to react with ingredients in the ink and fountain solution to create scale and sludge in the offset printing system. Such defect can be prevented by adding a chelating compound, for example organic phosphonic acids, phosphonalkanetricarboxylic acid, ethylenetetraacetic acid, nitrilotriacetic acid, 1-hydroxyethane-1,1-diphosphonic acid, and their corresponding salts.

Further, the fountain solution may comprise other additives such as various kinds of coloring agents and anticorrosive agents. For instance, coloring agents may preferably be food dyes. The corrosion inhibitor protects the printing plate, press and associated components from corrosion. Corrosion inhibitors may include ammonium, sodium, potassium or magnesium nitrites or nitrates or combinations of these, molybdates, tungstates or vanadates and various phosphates and silicates. Examples of suitable organic corrosion inhibitors include benzotriazoles, tolyltriazoles and derivates thereof.

Therefore, in a preferred embodiment there is provided for the method according to the invention wherein the fountain solution comprises a compound selected from the group consisting of a hydrophilic polymer, a wetting agent, a solvent, a biocide, surfactant, anti-corrosive agent, coloring agent, a chelating compound, a hydrotrope, non-pilling agent, evaporation inhibitors, or combinations thereof.

As explained above, the fountain solution with a pH value at or below pH=3.0 or at or above pH=8.5 is applied during an interval between two periods of printing. Such interval can for example be during maintenance, overnight, during the weekend etc. Therefore, in a preferred embodiment there is provided for a method according to the invention wherein the period of the interval between two periods of printing is selected from the group consisting of at least 30 minutes, at least 90 minutes, at least 360 minutes, at least 600 minutes, at least 24 hours, at least 48 hours.

In particular, the method according to the invention becomes increasingly effective with increasing interval periods.

The period of continuous printing, before being interrupted by an interval between two periods of printing can for example be at most 1, 2, 3, 4, 5, 6, 7, 8, 9, 10, 11, 12, 13, 14, 17, 24, 48, 96, 128, 200, 240, 360, 720, 1440 hours. Longer periods, for example 1 year or 2 years of printing before an interval between two periods of printing is applied can lead to reduced efficacy of the method according to the invention, as the period of printing would allow microorganism growth to occur for a prolonged period.

The pH value of the fountain solution can be modified with the use of any pH-changing compound or solution. However preferably there is provide for a method according to the invention wherein the pH value of the fountain solution during the interval between two periods of printing is regulated by addition of an aqueous solution of a compound selected from the group consisting of lactic acid, gluconic acid, sulphonic acids, toluenesulfonic acid, NaOH, KOH.

Examples of strong acids are sulphuric acid, hydrochloric acid, nitric acid. Examples of strong bases are KOH, NaOH, NH4OH, or selected from the group of organic or inorganic acids with a low pKa value and bases with a low pKb value. It has been found that any organic or inorganic compound can be used, but the above compounds are preferred. In general preferred are those compounds with either a low pkA, i.e. with a pKa of between 4, 3, or 2 or low pkB value of between 4, 3, or 2 (i.e. having a high degree of dissociation in aqueous solution, so a high dissociation constant) These are generally known as strong acids or bases.

In a particular preferred embodiment, there is provided a method according to the invention wherein the fountain solution is prepared from a fountain solution concentrate wherein

(1) the fountain solution concentrate is an aqueous concentrate having either (1a) a pH value at or below pH=3.0, or (1b) a pH value at or above pH=8.5;
(2) the fountain solution is prepared by admixing the fountain solution concentrate with an aqueous agent, preferably water, and the pH value is brought to a pH between pH=3.0 and pH=8.0, preferably between and including pH=3.5 and pH=5.7, even more preferably between and including pH=4.0 and pH=5.5 by, in case of (1a), addition of a base, or by, in case of (1b), addition of an acid;
(3) During an interval between two periods of printing the pH value of the fountain solution is brought to (3a) a pH value at or below pH=3.0, by, in case of (1a), addition of said fountain solution concentrate, or by, in case of (1b), addition of an acid or (3b) to a pH value at or above pH=8.5, by, in case of (1a) addition of a base, or, in case of (1b) addition of said fountain solution concentrate to the fountain solution;
(4) At the end of the interval between two period of printing, the pH value of the fountain solution is brought to a pH between pH=3.0 and pH=8.5, preferably between and including pH=3.5 and pH=5.7, even more preferably between and including pH=4.0 and pH=5.5 by, in the case of (3a), addition of, in case of (1a), a base, or, in case of (1b) a base, or preferably said fountain solution concentrate, or by, in the case of (3b), addition of, in case of (1a), an acid, or preferably said fountain solution concentrate, or by, in the case of (1b), an acid;
(5) Optionally in (4) aqueous solution, preferably water, is added to compensate for the additional fountain solution concentrate added to the fountain solution.

The term “fountain solution concentrate” is known to the skilled person and refers to a concentrated solution that is diluted by the addition of an aqueous agent, normally water, to form a functional fountain solution for use in a printing system, process or device. The concentration might comprise all additives present in a fountain solution, but might also comprise a selection thereof. Additional additives might for example be directly added to the fountain solution, at the same time the aqueous agent is added (or thereafter).

Normally, after preparation of the fountain solution, conductivity of the solution is determined as a measure of the strength or concentration of the fountain solution, which is important because it will indicate an error in mixing. In addition, pH values are normally determined as this is necessary to determine the solution's chemical composition. Method for determining conductivity and pH values are known to the skilled person. Also spectroscopic means of measuring like for example the Optoscan of Unisensor (Karlsruhe, Germany) can be used.

It has been found that, depending whether the pH value is increased to above or at pH 8.5 or to a value at or below pH 3.0, in particular the fountain solution concentrate as described above can very suitably used to restore the pH value to between pH 3.0 and pH 8.5 (depending on the pH value that is desirable during a period of printing). By using said concentrated solution, the chemical composition of the fountain solution remains the same, guaranteeing optimal efficacy of the fountain solution. In addition, if required, for example in case the conductivity of the fountain solution is not within the desirable limits, additional water can be added in order to reduce the salt concentration in the fountain solution (compensate, as mentioned in the claims). With the help of for example automatic systems, both conductivity, pH value and chemical composition of the fountain solution can be tightly regulated.

Again, it is preferred to, in the method according to the invention, initially increase the pH value in the interval between two periods of printing, either by using a base, or by using an alkaline fountain solution concentrate, and next to bring back the pH to the pH value desirable for printing either by the addition of an acid, or by the addition of an acid fountain solution concentrate as described above.

In another preferred embodiment, there is provided a method according to the invention wherein during an interval between two period of printing the fountain solution (as described herein) is used to rinse and/or clean the printing device.

It has been found that in addition to the prevention or inhibition of the growth of microorganisms, in addition the fountain solution concentrate with a pH value at or below 3.0 or at or above pH 8.5 can very suitably be used for cleaning and rinsing the printing system and or device.

In another aspect of the invention there is provided for the use of a base, an acid, or a fountain solution concentrate with a pH value below 3.0 or a fountain solution concentrate with a pH value above 8.5 for regulating the pH of a fountain solution as defined above. Preferably said use is with a fountain solution that is substantially (or essentially) free of a pH buffer system.

In another aspect there is provided a fountain solution concentrate with a pH value below 3.0 or with a pH value above 8.5. Preferably, said fountain solution concentrate (not pure water) is substantially free of a pH buffer system, as defined and discussed above.

The person skilled in the art will understand that further preferences with respect to the use or with respect to the fountain solution are those as already discussed with respect the method according to the invention.

As explained above, preferably the fountain solution or the fountain solution concentrate is free of, substantially free of, or has reduced levels of a pH buffer system. Consequently, the level of electrolytes in the fountain solution or, in particular, the fountain solution concentrate, suitable for use in the current invention, is or can be reduced in comparison to when the fountain solution comprises a pH buffer system to maintain and regulate the pH value of the solution.

Either low levels of hydrotropes can thus be used in a fountain solution concentrate or fountain solution to maintain the same level of solubilization of hydrophobic compounds, or the same level can be used to solubilize even more hydrophobic compounds in the fountain solution or fountain solution concentrate.

In addition, it has been found that by having a fountain solution concentrate with a pH value at or above pH 8.5, or at or below pH 3.0, the fountain solution concentrate does not require the presence of any biocide to prevent the growth of microorganisms during storage of the concentrate.

Moreover, such fountain solution concentrates have the additional advantages that various additives that were difficult to dissolve in the fountain solution concentrations in the art, can, due to the pH value of the fountain solution concentrate according to the invention, and in addition (in a preferred embodiment) due to the absence of a pH buffer system, and possibly biocide, be dissolved more easily and at higher concentration, in a fountain solution concentrate according to the invention.

While the invention has been described, disclosed, illustrated and shown in various terms of certain embodiments or modifications, which it has presumed in practice, the scope of the invention is not intended to be, nor should it be deemed to be, limited thereby and such other modifications or embodiments as may be suggested by the teachings herein are particularly reserved, especially as they fall within the breadth and scope of the claims here appended.

### Examples

The fountain solution concentrate used in the example 1 below can comprise:

Polyethyleneoxide polymer: 5 to 500 ppm of a Polyox™ powder with a molecular weight of about 200,00 to about 7,000,000.

Inorganic/organic salt: 0.2 to 2.5 wt. % a phosphate, monohydrogen phosphate, dihydrogen phosphate, methaphosphate, pyrophosphate, acetate, citrate, malate and the like.

Buffering acid: 0.1 to 7 wt. % of a weak acid like phosphoric, acetic, malic, citric and the like.

Chelating agent: 0.1 to 1.5 wt. % of a aminophosphonic or a aminocarboxylic chelating acid or salt thereof.

Biocide: 0.1 to 1.25 wt. % of an effective biocide like glutaraldehyde, dimethyldimethylol hydantoin, isothiazolines, e.g., Kathon™, 2-bromo, 2-nitropropane 1-2diol, formaldehyde, glyoxal, 3-iodo-2-propynyl butylcarbamate, sodium dimethyldithiocarbamate and the like.

Desinsitizing water soluble polymer: 0.5 to 10 wt. % consisting of gum Arabic, carboxymethyl cellulose, hydroxypropyl cellulose, dextrins or other polysaccharides.

Glycols: 1.5 to 10.0 wt. % of a glycol, glycol ether or glycol ester.

Surfactant/wetting agent: 0.5 to 4.5 wt. % of a non-ionic or anionic surfactant or wetting with a HLB in the range of 2 to about 10.

Hydrotope: 1.0 to 5.0 wt. % of a hydrotope like sodium benzene sulfonate, cumen sulfonate and the like. Pure water-add to 100 wt. %. The pH value of the concentrate was set to pH 2.0 by the further addition of an acid. The above ingredients can also be used within the limits, as described, to prepare fountain solutions with a pH range of about 4.0 to about 5.5.

### Example 1

During an interval of 48 hours (weekend) between two periods of printing of a offset printing device for printing newspapers, the pH value of the fountain solution was increased to pH=10 by the addition of a concentrated aqueous KOH solution to the fountain solution.

During the interval, the fountain solution with pH=10 was used to rinse and clean the printing system. At the end of the interval, the pH value of the fountain solution was returned to pH=5.1 by addition of the acidic fountain solution concentrate having a pH value of 2.0

The above was repeated during a period of 2 months. During said period there have been no observation of the negative consequence of growth of bacteria in the fountain solution or printing device, like increase of the pH value in the fountain solution during printing, breakdown of essential components in the fountain solution concentrate, the presence of microorganisms in the form of deposits (normally slimy substance), for example in the form of filter-clogging deposits and the like.

### Example 2

Same as above, but with a fountain solution concentrate not comprising a pH buffer system. Comparable results were obtained.

### Example 3

Same as under 2, but with a fountain solution concentrate without biocide. Comparable results were obtained.

Clearly, the examples suggest the efficacy of the method according to the invention.

1.-14. (canceled)

15. Method for inhibiting or preventing growth of micro-organisms in a printing device to which during a period of printing a fountain solution is provided, characterized in that during an interval between two periods of printing the pH value of the fountain solution is brought to a pH value at or below pH=3.0 or to a pH value at or above pH=8.5 and at the end of the interval between two periods of printing the pH value of the fountain solution is brought to a pH value between pH=3.0 and pH=8.5.

16. Method according to claim 15, wherein at the end of the interval between two periods of printing the pH value of the fountain solution is brought to a pH value between and including pH=3.5 and pH=5.7, preferably between and including pH=4.0 and pH=5.5.

17. Method according to claim 15, wherein the pH value in the interval is brought to a pH value at or below pH=2.5, preferably at or below pH=2.0, or wherein the pH value in the interval is brought to a pH value at or above pH=9.0, preferably at or above pH=10.0.

18. Method according to claim 15, wherein the printing device is for off-set printing.

19. Method according to claim 15, wherein the fountain solution is substantially free of a pH buffer system.

20. Method according to claim 15, wherein the fountain solution is substantially free of biocide.

21. Method according to claim 15, wherein the fountain solution comprises a compound selected from the group consisting of a hydrophilic polymer, a wetting agent, a biocide, a solvent, surfactant, anti-corrosive agent, coloring agent, a chelating compound, a hydrotropic, non-pilling agent, evaporation inhibitors, and combinations thereof.

22. Method according to claim 15, wherein the period of the interval between two period of printing is selected from the group consisting of at least 30 minutes, at least 90 minutes, at least 360 minutes, at least 600 minutes, at least 24 hours, at least 48 hours.

23. Method according to claim 15, wherein the pH value of the fountain solution during the interval between two periods of printing is regulated by addition of an aqueous solution of a compound selected from the group consisting of lactic acid, gluconic acid, sulfonic acid, toluenesulfonic acid, NaOH, KOH.

24. Method according to claim 15, wherein the fountain solution is prepared from a fountain solution concentrate wherein
(1) the fountain solution concentrate is an aqueous concentrate having either (1a) a pH value at or below pH=3.0, or (1b) a pH value at or above pH=8.5;
(2) the fountain solution is prepared by admixing the fountain solution concentrate with an aqueous agent, preferably water, and the pH value is brought to a pH between pH=3.0 and pH=8.0, preferably between and including pH=3.5 and pH=5.7, even more preferably between and including pH=4.0 and pH=5.5 by, in case of (1a), addition of a base, or by, in case of (1b), addition of an acid;
(3) during an interval between two periods of printing the pH value of the fountain solution is brought to (3a) a pH value at or below pH=3.0, by, in case of (1a), addition of said fountain solution concentrate, or by, in case of (1b), addition of an acid or (3b) to a pH value at or above pH=8.5, by, in case of (1a) addition of a base, or, in case of (1b) addition of said fountain solution concentrate to the fountain solution;
(4) at the end of the interval between two period of printing, the pH value of the fountain solution is brought to a pH between pH=3.0 and pH=8.5, preferably between and including pH=3.5 and pH=5.7, even more preferably between and including pH=4.0 and pH=5.5 by, in the case of (3a), addition of, in case of (1a), a base, or, in case of (1b) a base, or preferably said fountain solution concentrate, or by, in the case of (3b), addition of, in case of (1a), an acid, or preferably said fountain solution concentrate, or by, in the case of (1b), an acid;
(5) Optionally in (4) aqueous solution, preferably water, is added to compensate for the additional fountain solution concentrate added to the fountain solution.

25. Method according to claim 1, wherein during an interval between two period of printing the fountain solution is used to rinse and/or clean the printing device.

26. Use of a base, an acid, or a fountain solution concentrate with a pH value below 3.0 or a fountain solution concentrate with a pH value above 8.5 for regulating the pH of a fountain solution as defined above.

27. Use according to claim 26, wherein the fountain solution is free of a pH buffer system.

28. A fountain solution concentrate with a pH value below 3.0 or with a pH value above 8.5.

29. A fountain solution concentrates according to claim 28, wherein said fountain solution concentrate is substantially free of a pH buffer system.
